(19) United States
(12) Patent Application Publication
(10) Pub. No.: US 2015/0073832 A1
(43) Pub. Date: Mar. 12, 2015

(54) SYSTEMS AND METHODS FOR DOCUMENTING A BLOOD DONATION COLLECTION PROCESS

(71) Applicants: James E. GOODNOW, II, Grass Valley, CA (US); Jonathan G. MORGAN, San Francisco, CA (US); James A. BANCROFT, Grass Valley, CA (US)

(72) Inventors: James E. GOODNOW, II, Grass Valley, CA (US); Jonathan G. MORGAN, San Francisco, CA (US); James A. BANCROFT, Grass Valley, CA (US)

(21) Appl. No.: 14/482,884

(22) Filed: Sep. 10, 2014

Related U.S. Application Data
(60) Provisional application No. 61/876,019, filed on Sep. 10, 2013.

(51) Int. Cl. G06F 19/00

(52) U.S. Cl. CPC G06F 19/322; G06F 19/36
USPC 705/3; 705/2

(57) ABSTRACT

Methods and apparatus collecting blood from patients and managing blood donations are provided, which may include any number of features. One feature is a blood collection device configured to collect blood and collection information from a patient. Another feature is a system and method for acquiring and receiving the blood and collection information, and entering the information into a blood records management system. Computing methods and systems are described which can acquire the desired data with screen scraping and enter the data into the blood records management system with terminal emulation.

### CROSS REFERENCE TO RELATED APPLICATIONS

This application claims the benefit of U.S. Provisional Appln. No. 61/876,019, filed Sep. 10, 2013, titled “Systems and Methods for Documenting a Blood Donation Collection Process”, which is incorporated herein by reference.

### INCORPORATION BY REFERENCE

All publications and patent applications mentioned in this specification are herein incorporated by reference to the same extent as if each individual publication or patent application was specifically and individually indicated to be incorporated by reference.

### FIELD

Described herein are devices and methods for use in blood donation and blood management. In particular, described herein are devices and methods for managing information related to the blood donations.

### BACKGROUND

Blood donation centers typically use a donor screening system (such as Donor-ID) during blood drives to document blood donations collected from new and previous blood donors. A donor screening system provides a number of important functions during the course of a blood drive, such as donor identification and elimination of eligibility problems prior to the actual blood donation. Donor screening systems are used to screen donors for health conditions or health history that may pose a risk to blood recipients, as well as providing information that will prevent someone from donating blood when it is unsafe for them to do such, for instance when the donor's hemoglobin level is too low.

Blood donation centers also use more comprehensive blood center information systems, such as SafeTrace, to track, manage, and report other functions related to the operation of the blood center, including management of blood inventory and blood distribution.

Donor screening systems (such as Donor-ID) and blood center information systems (such as SafeTrace) can be broadly categorized as Blood Establishment Computer Software (BECS) since they both are designed to receive and store data used by blood establishments. More modern BECS systems can be designed to operate in modern computing environments, such as Microsoft Windows or Apple OS X, while older BECS systems can operate in a terminal-based environment such as UNIX.

The use of two or more data management systems that do not interface with each other electronically results in the need to manually enter data from the donor screening system into the blood center information systems. Manual data entry by people involves unnecessary steps, for example, each donation event or record must be printed out from the donor screening system before it can be entered into the blood center information system. Manual data entry is inherently slow and error-prone, and has disadvantages for blood centers, including 1) predictable but unavoidable data entry errors such as typographical errors, omissions, and duplicate entries, resulting in extra effort and time needed to resolve the errors and ensure clean data, 2) Slowed processing during times of high blood donation activity, when blood may be needed without delay, and 3) Discarding and wastage of collected blood when data is not processed in a timely manner.

### SUMMARY OF THE DISCLOSURE

In one embodiment, a Blood Establishment Computer System (BECS) automated data entry emulator is provided comprising a non-transitory computer-readable storage medium storing a set of instructions capable of being executed by a computer, that when executed by the computer causes the computer to receive one or more sets of data from one or more medical devices comprising blood collection information and/or donor information, format the data sets by formatting data within each set of data into data entry fields corresponding to data entry fields of a BECS system, automatically write the formatted data sets into data entry fields of the BECS system, generate a list of exceptions referencing any of the data sets for which the BECS system indicates an error or did not accept data from the data set, and present the list of exceptions to a user to manually correct the data within the data sets referenced by the list of exceptions.

In some embodiments of the BECS automated data entry emulator, the set of instructions when executed by the computer cause the computer to include on the list of exceptions a reference to any of the sets of data for which data cannot be formatted to correspond to the data entry fields of the BECS system.

In other embodiments of the BECS automated data entry emulator, the set of instructions when executed by the computer cause the computer to apply a set of rules to the data within each set of data to determine if additional data is missing and to include a reference to any of the sets of data for which additional data is missing.

In one embodiment of the BECS automated data entry emulator, the set of instructions when executed by the computer cause the computer to present the list of exceptions to the user to manually correct the data sets by providing an emulated BECS data entry screen.

In some embodiments of the BECS automated data entry emulator, the set of instructions when executed by the computer cause the computer to log into the BECS system and determine the format of the data entry fields of the BECS system.

In one specific embodiment of the BECS automated data entry emulator, the set of instructions when executed by the computer further causes the computer to automatically write the corrected data sets from the formatted sets of data.

In some embodiments of the BECS automated data entry emulator, the set of instructions when executed by the computer further causes the computer to generate an updated list of exceptions referencing any of the data sets for which the BECS system indicates an error or did not accept data from the data set.

A Blood Establishment Computer System (BECS) automated data entry emulator is also provided, comprising a non-transitory computer-readable storage medium storing a set of instructions capable of being executed by a computer, that when executed by the computer causes the computer to receive one or more sets of data from one or more medical devices comprising blood collection information and/or donor information, format the data within each set of data into data entry fields corresponding to data entry fields of a BECS system, generate a first list of exceptions referencing any of the sets of data which cannot be formatted to correspond to the data entry fields of the BECS system, apply a first set of exceptions rules to the data within each data set to determine if additional data is missing from one or more of the sets of data and include a reference to any data set missing the additional data on the first list of exceptions, automatically write the formatted data sets not referenced on the first list of exceptions into data entry fields of the BECS system, generate a second list of exceptions referencing any of the data sets for which the BECS system indicates an error, and present the first and second list of exceptions to a user to manually correct the data within the data sets referenced by the first and second list of exceptions.

A method of managing blood collections is also provided, comprising the steps of receiving, with a computing system, blood collection information from a blood collection device, inputting, with a terminal emulation software program of the computing system, the blood collection information into a blood records management system, and identifying, with a screen scraping process of the terminal emulation software program, errors in the blood collection information.

In some embodiments, the method further comprises, in response to identifying the errors in the blood collection information, flagging the identified errors for review by a user.

In another embodiment, the method further comprises applying a set of rules to the blood collection information to determine if additional data is missing and to include a reference to any of the sets of data for which additional data is missing.

In one embodiment, the method further comprises presenting the identified errors to the user to manually correct the inputting of blood collection information into the blood records management system.

In some embodiments, errors in the blood collection information are selected from the group consisting of time and location of the blood collection, amount of blood withdrawn, blood type, employee ID of the phlebotomist responsible for collection of the blood, elapsed time of blood collection, and interruptions of the blood donation process.

In one embodiment, the blood donor screening system comprises Donor-ID. In another embodiment, the blood records management system comprises SafeTrace.

In some embodiments, the inputting step further comprises emulating, with the terminal emulation software program of the computing system, manual data entry of the blood collection information into the blood records management system.

Some embodiments further comprise the step of formatting the blood collection information into data entry fields corresponding to data entry fields of the blood records management system.

A method of managing blood collections is also provided, comprising the steps of receiving, with a computing system, blood collection information or donor information from a blood donor screening system or a blood collection device, emulating, with the computing system, the blood collection information or donor information into a blood records management system, and identifying, with the computing system, errors in the blood collection information, errors in the donor information, or errors produced by the blood records management system.

In some embodiments, the method further comprises, in response to identifying the errors in the blood collection information or donor information, flagging the identified errors for review by a user.

In another embodiment, the method further comprises applying a set of rules to the blood collection information or donor information to determine if additional data is missing and to include a reference to any of the sets of data for which additional data is missing.

In one embodiment, the method further comprises presenting the identified errors to the user to manually correct the inputting of blood collection information or donor information into the blood records management system.

In some embodiments, errors in the blood collection information or donor information are selected from the group consisting of time and location of the blood collection, amount of blood withdrawn, blood type, employee ID of the phlebotomist responsible for collection of the blood, elapsed time of blood collection, and interruptions of the blood donation process.

In one embodiment, the blood donor screening system comprises Donor-ID. In another embodiment, the blood records management system comprises SafeTrace.

In some embodiments, the inputting step further comprises emulating, with the terminal emulation software program of the computing system, manual data entry of the blood collection information or donor information into the blood records management system.

Some embodiments further comprise the step of formatting the blood collection information or donor information into data entry fields corresponding to data entry fields of the blood records management system.

A blood collection and tracking system is provided, comprising a blood collection device configured to collect blood from a patient and to collect information relating to the collected blood, a donor screening system configured to provide information relating to the patient's eligibility to donate blood, a blood records management system comprising a database of information relating to blood donation and distribution, and a batch data entry logic module configured to receive information relating to the collected blood from the blood collection device, configured to receive information relating to the patient's eligibility to donate blood from the donor screening system, and further configured to enter the information relating to the collected blood and the patient's eligibility to donate blood into the blood records management system with a terminal emulation algorithm.

### BRIEF DESCRIPTION OF THE DRAWINGS

FIG. 1 is a schematic illustration of a blood donation process.

FIG. 2 is an illustration of conventional manual data entry into a blood records management system.

FIG. 3 is an illustration of automated computer entry into a blood records management system with a computing system of the present invention.

FIG. 4 is a schematic drawing showing the features and responsibilities of a computing system of the present invention.

FIG. 5 illustrates some technologies used by the computing system of the present invention.

FIG. 6 is a functional diagram illustrating one embodiment of a system and method for documenting a blood collection process.

### DETAILED DESCRIPTION OF THE DISCLOSURE

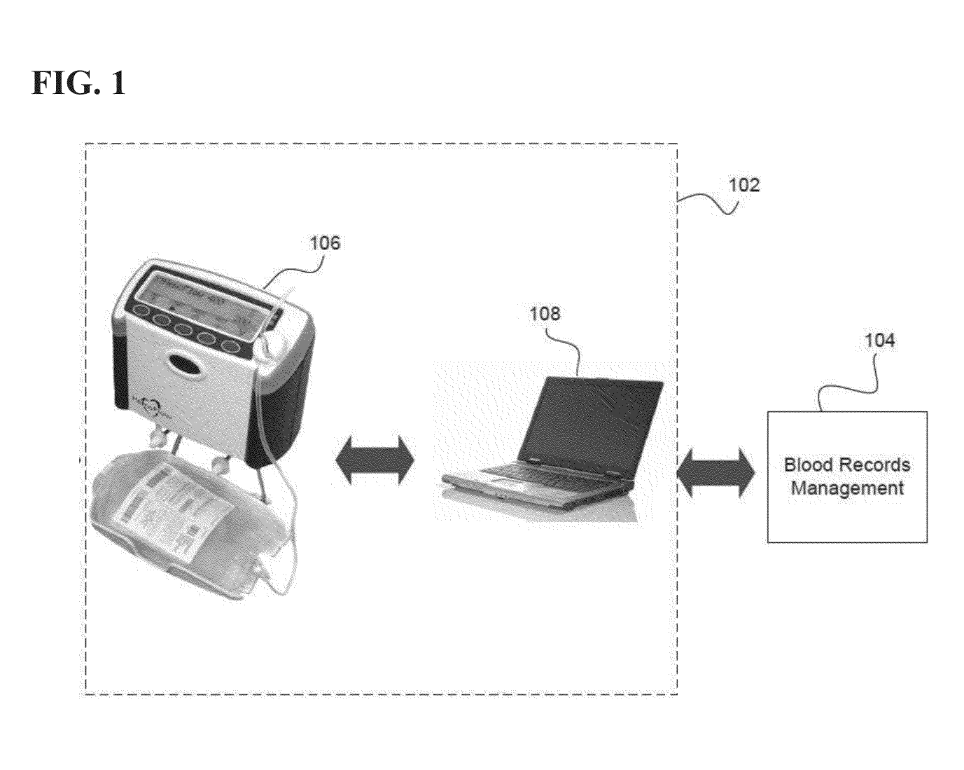

Managing blood donations generally includes a blood and data collection process, which can comprise the collection of a blood donation from a blood donor, as well as collection of information relating to the collection of the blood donation. Referring to FIG. 1, a blood and data collection system and process 102 can comprise a blood collection device 106 and a donor screening system 108, which can be software code stored and executed on a computer system or network. The donor screening system can be, for example, software code stored and executed on a personal computer, a tablet, smartphone, or other type of electronic device. The blood collection device 106 can be configured to both collect blood from the blood donor as well as collect information relating to the collection of the blood donations. This information relating to the collection of blood donations can comprise, for example, time and location of the blood collection, amount of blood withdrawn, blood type, employee ID of the phlebotomist responsible for collection of the blood, elapsed time of blood collection, interruptions of the blood donation process, etc.

In some embodiments, the data from the blood and data collection system and process 102 can be entered into a blood records management system 104. The blood records management system 104 can comprise software code stored and executed on a computer system or network, and can be configured to track, manage, and report information and functions related to the operation of one or more blood centers, including management of blood inventory, blood donation information, and blood distribution. In some embodiments, as will be described in more detail below, a computing system comprising a batch data entry logic module can be configured to receive information from the blood collection device(s) and the donor screening system, and automatically enter the received information into the blood records management system. The module can be configured to acquire the information from the blood collection device(s) and the donor screening system automatically (e.g., with screen scraping), or that information can be entered manually into the module. In some embodiments, the module can be configured to automatically enter the received information into the blood records management system with a terminal emulation software algorithm executed by the module.

Blood donation centers typically use a donor screening system such as Donor-ID during blood drives to document blood donations collected from new and previous blood donors. Referring to FIG. 1, the donor screening system 108 can include any information collected about the donor or the collected blood by either the blood donation center or the blood collection device 106. A donor screening system typically provides a number of important functions during the course of a blood drive such as donor identification and elimination of eligibility problems prior to the actual blood donation. Donor screening systems are used to screen donors for health conditions or health history that may pose a risk to blood recipients, as well as providing information that will prevent someone from donating blood when it is unsafe for them to do so, for instance when the donor's hemoglobin level is too low. The information collected with a donor screening system, can be inputted into the blood collection device 106 during a blood collection process, or otherwise can be provided to a blood records management system 104 during that step of the process.

When a blood donation is completed by a blood collection device 106 and a donor screening system 108, the data can be entered into a blood records management system 104 which can be responsible for managing and storing blood stockpiles, tracking stored volumes of the various blood types, and distributing the blood to places in need of blood donations (e.g., hospitals and other medical centers). Blood donation centers typically use more comprehensive blood center information systems for the blood records management system 104, to track, manage and report other functions related to the operation of the blood center, including management of blood inventory and blood distribution. The donor screening system 108 (such as Donor-ID) and the blood records management system 104 (such as SafeTrace) can be categorized as Blood Establishment Computer Software (BECS) since they both are designed to receive and store data used by blood establishments. Prior to the invention described herein, data entry relating to blood collection events and donor information was manually inputted into the blood records management system 104. Due to the labor intensive manual entry of data into this system, the transition from blood collection to blood management is inefficient and prone to human error, resulting in a high percentage of donated blood being wasted.

The use of two data management systems that do not interface with each other electronically previously resulted in the need to manually enter data from the donor screening system (e.g., donor screening system 108) into the donor and blood records management system (e.g., blood records management 104). Data entry by people involves unnecessary steps, for example each blood donor medical record (DMR) must be printed out from the donor screening system before it can be entered into the blood records management system. Manual data entry is inherently slow and error-prone, and has disadvantages for blood centers including: predictable but unavoidable data entry errors, such as typographical errors, omissions, and duplicate entries, resulting in extra effort and time needed to resolve the errors and ensure clean data, slowed processing during times of high blood donation activity, when blood may be needed without delay, or discarding and wastage of collected blood when data is not processed in a timely manner.

A computing system and method of the present disclosure has a simple purpose, to replicate the data entry activities necessary to transfer data from blood collection devices and a donor screening system (e.g., Donor-ID) to a blood records management system (e.g., SafeTrace). However, this automated data entry activity can be reserved only for those data entries that don't involve decision-making by the computing system and method. An important distinction to be made is that computing system and method does not perform direct data transfer or interfacing between two database systems. The system and method can instead replicate data entry keystrokes, automating the most mechanical and manual portion of the entire process. This can result in minimal procedural and system changes, and draws on all established systemic quality control checks.

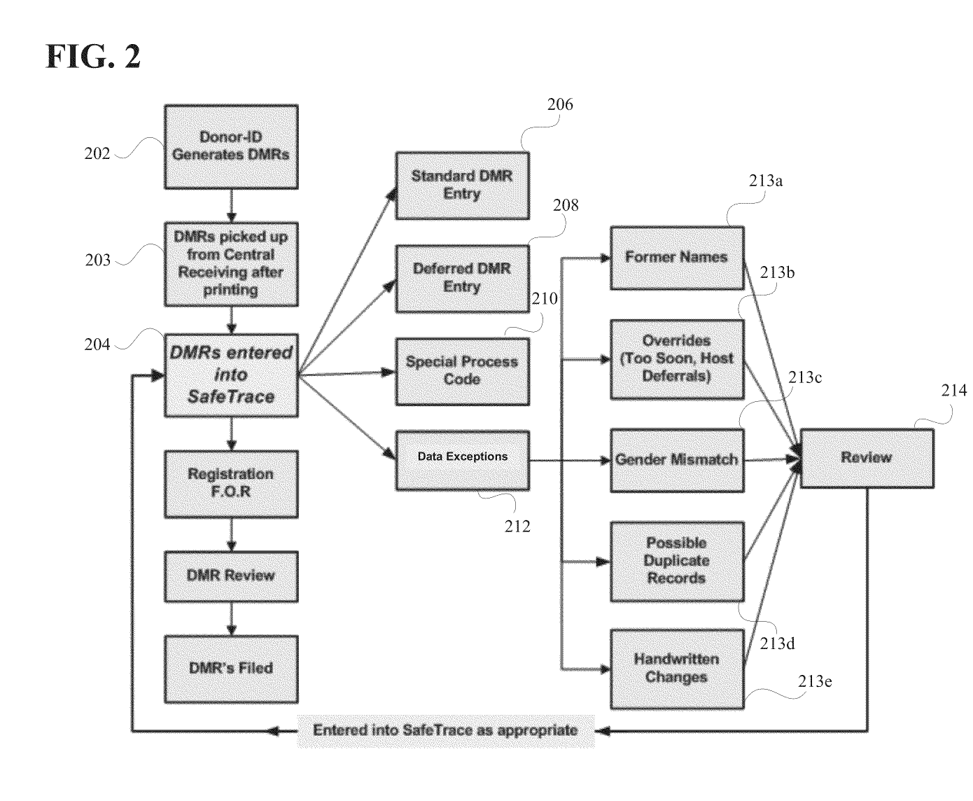

One example of a manual process typically in use at blood centers is diagrammed in FIG. 2. In FIG. 2, DMRs generated by a donor screening system such as Donor-ID at step 202, or DMRs picked up from a central receiving office after printing at step 203, can be manually inputted into a blood records management system at step 204. The entries can be categorized as Standard DMR Entries 206, Deferred DMR Entries 208, Special Process Codes 210, and Data Exceptions 212. Standard DMR Entries can be data entries where everything appears to be in order at the entry step. Deferred DMR entries can be entries flagged for entry at a later time. Special Process Codes can be entries that require special codes or overrides during entry. Data exceptions can comprise, for example, Former/Different Names 213a found in the system, Overrides 213b (donor giving blood too soon, host deferrals), gender mismatch 213c, duplicate records 213d, handwritten changes 213e, etc. These problem entries are typically reviewed by a person at step 214 and then the DMR is re-entered into the blood records management system once the problem has been identified and corrected.

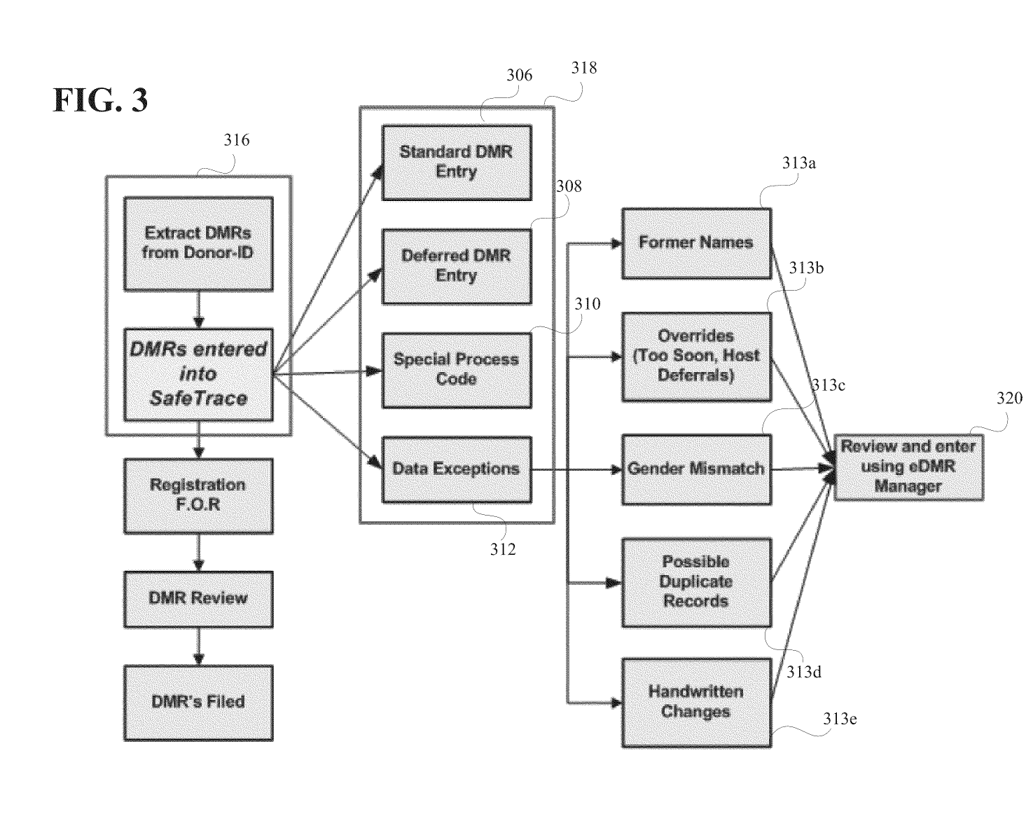

Adding a computing system and method capable of automating to this entry process results in some procedural changes, which are due to the enhanced data exception accuracy provided by an automated process. These changes are shown in FIG. 3. In FIG. 3, the steps encapsulated by boxes 316, 318, and 320 can be processed and implemented by the computing system and method of the present disclosure.

Referring to box 316, a computing system operating on a computing device, such as a computer having a CPU and memory running the computing system, can extract DMRs from the donor screening system. This can be done, for example, by scanning print-outs from the donor screening system or receiving the information directly from the donor screening system or the blood collection device. In another embodiment, the DMRs can be extruded with screen scraping technology directly from the blood collection device and/or from the donor screening system. The information can be received through a direct wired connection, or through a wireless connection, for example.

The DMRs can be entered into the blood records management system (e.g., SafeTrace) directly with the computing system of the present disclosure. For example, the computing system of the present disclosure can use terminal emulation to log into the blood records management system as a “user”, and input the data following the business rules, exception handling, and function keys within the blood records management system. The computing system is designed to emulate exactly what is done by a data entry person in the blood records management system, without requiring any manual data entry.

The automated entry of DMRs into the blood records management system (shown in box 316) can include the categories of entries shown in box 318, and discussed above. Data exceptions, such as Former/Different Names 313a, Overrides 313b, gender mismatch 213c, duplicate records 313d, and handwritten changes 313e can also be automatically entered by the terminal emulation software. These data exceptions, along with special process codes, and the deferred DMR entry can be further reviewed at box 320. The data exceptions can be automatically flagged during the automated entry of DMRs into the blood records management system. In some embodiments, the emulation software can flag specific data entry points or exceptions that need to be reviewed at box 320. It should be noted that the original process steps of FIG. 2 can still be done if necessary, for example in the case of computer system problems that prevent the computing system and method from being operational. This system and method described herein can replace manual data entry while leaving the infrastructure for manual data entry intact.

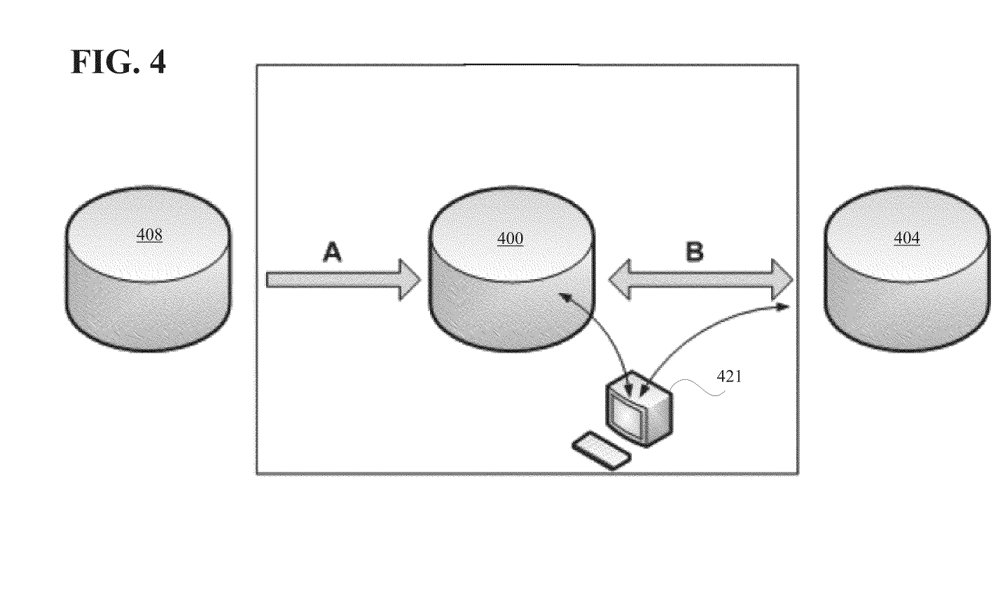

An overview of this process is diagrammed in FIG. 4, illustrating the responsibilities of computing system 400 (the automated computing system and method described above). As shown in FIG. 4, the computing system 400 can receive DMRs as an input from the donor screening system 408 at arrow A, and enter data into the blood records management system 404 at arrow B. As described above, the DMRs can be inputted into the automated computing system with a screen scraping program or process, or alternatively can be scanned or manually entered into the automated computing system. The automated computing system can then transmit the data from the donor screening system into the blood records management system with emulation software. In the event of data exceptions between the automated computing system and the blood records management system, the computing system 400 can also provide a user interface 421 running on a workstation for handling data exceptions between the computing system 400 and the blood records management system.

Because of the use of terminal emulation step between the automated computing system and the blood records management system 404, this is not an automated data transfer - it is an automation of the data entry performed by a human operator, even down to the duplication of keystrokes. Therefore, use of the computing system of the present disclosure makes no functionality changes to either the donor screening system (e.g., Donor-ID) or the blood records management system (e.g., SafeTrace). The software functionality of terminal emulation can be implemented as a series of actions in response to expected responses of the blood records management system.

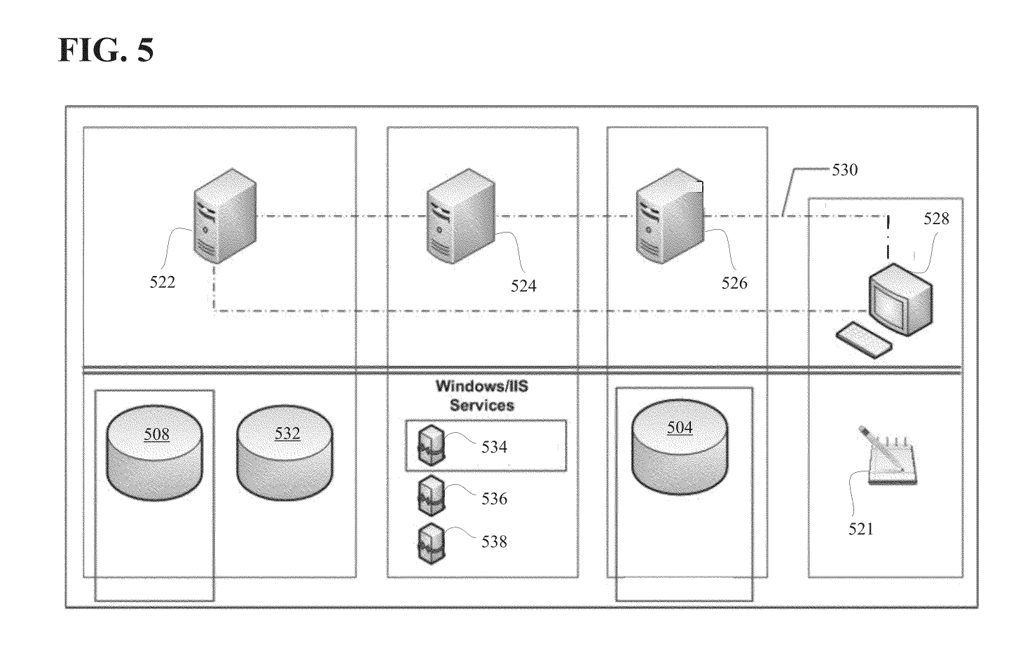

The computing system of the present disclosure uses proven technologies to transfer data from the donor screening system to the blood records management system. FIG. 5 shows the basic organization of the computing system (computing system 400 from FIG. 4 and described above) and related components. The computing system can include a Windows database server 522, a Windows network server 524, a UNIX server 526, and a Windows workstation 528 all connected with a communications network 530. The computing system can implement and run software infrastructure described herein. In one embodiment, the Windows database server 522 can run the donor screening system 508 and DMR database tables 532. The Windows network server 524 can run software services such as terminal emulation 534, web services 536, and synchronization services 538. The computing system has a number of built-in safety features. One of its most comprehensive safety features is the use of terminal emulation rather than direct database-to-database record transfers. This is described in more detail below.

During data extraction of DMRs by the computing system of the present disclosure from the donor screening system, standard network and database security configuration parameters can be present to prevent any access other than read-only by the computing system.

At this point, the computing system can use emulation to enter data into the blood records management system. Terminal emulators are software programs that behave like a hardware terminal or a dumb terminal. Unlike a generic computer such as a personal computer, hardware and dumb terminals are specialized terminals meant to be used for access to specific centralized or back-end computers. These computers may be mainframes, minicomputers, or servers. In this case, the back-end computer can be a Sun Server V240 with the Solaris 9 operating system, running SafeTrace and Oracle 9i Enterprise Edition, and the terminal being emulated can be a VT220. Flynet provides the low-level emulation function for the SafeTrace Web service to operate with.

Instead of transferring data directly from database to database over a network, the computing system of the present disclosure can act like a user who logs in to a blood records management system, and who enters data by typing at a keyboard. The computing system of the present disclosure can process the donor medical records and send the appropriate keystroke data to the terminal emulator. The terminal emulator can then interact with the blood records management system as if it were a person typing on a keyboard. The terminal emulator enters data, acts on responses from the blood records management system, and collects status messages, including error and success messages, displayed by the blood records management system. Identifying responses and status messages can be accomplished with screen-scraping.

Using terminal emulation in this manner means that the blood records management system application does not have to be modified in any way for the computing system of the present disclosure, and that all security and edit checks normally applied by the blood records management system during manual data entry remain in place and active. This method avoids the necessity to develop complex software that embodies all of the blood records management system logic and edit checks, since they are operational and in force during the data entry.

The computing system of the present disclosure only deals with data that is part of completely entered batches. The computing system detects new batches once they have been entered into the donor screening system database according to the established data entry methods for the donor screening system. Detection of an unprocessed batch starts the process of transferring the batch's data to the blood records management system. During this process, each DMR is either successfully entered into the blood records management system or rejected as a data exception. All activity related to batches and DMRs is logged. Data exceptions, or Donor Medical Records that were not automatically processed, are stored for later manual processing a Graphical User Interface (GUI) of the computing system. DMRs are rejected by the blood records management system according to rules configured as part of the blood records management system, and are applied in exactly the same way as they are when data is entered by a human operator. These rules do not need to be and are not implemented in the computing system. In order to change the rules for acceptable vs. unacceptable data, the blood records management system would be reconfigured, just as it is for manual data entry.

Data exceptions can be categorized as errors identified from BECS (e.g., either the donor screening system or blood records management system), or alternatively as errors identified by the computing system of the present disclosure. The first category, errors identified from BECS, result from scraping the screen of either BECS system with the computing system of the present disclosure and identifying if there is an error. If the computing system identifies an error, it can move on to the next data entry. The second category, errors identified by the computing system of the present disclosure, can be errors identified by the computing system prior to even attempting to enter data into the blood records management system. These types of errors can include, for example, improper age of a donor (under 18), improper credentials, duplicate records, improper type of donation, improper amount of blood drawn, etc. If the computing system identifies this type of error, the record will be flagged prior to even attempting to automatically input the data into the blood records management system.

The computing system of the present disclosure is designed to be used by trained blood center personnel who are familiar with donor medical records, donor screening systems such as Donor-ID and blood records management systems such as SafeTrace.

The computing system of the present disclosure is designed to process only data that has been previously entered into a donor screening system and has passed that system's rather minimal edit checks. The computer system can enter this data into the blood records management system such as SafeTrace, subject to meeting the criteria defined by the blood records management system's edit checks and data quality constraints. The computing system does not directly apply, use, or require any data constraints.

The computing system of the present disclosure provides significantly faster data entry speed with complete accuracy, and also provides an easier, more-efficient and less error-prone method of dealing with exceptions. In addition, the computing system provides detailed logging of all actions and data transactions, including those made manually through the system.

The methodology and process described above has wide applicability in other areas of healthcare where electronic patient medical records must be maintained with data inputs from hundreds of devices (both hardware and systems). As an example, a patient may be in the intensive care unit of a hospital and hooked up to multiple medical devices which are either monitoring the vital signs of that patient or dispensing fluids and pharmaceuticals. The data associated with these monitoring and dispensing systems should logically become part of the patients complete medical record. Today in many circumstances this information must be rekeyed into the EMR of the patient. The same system used to automate data entry of device and donor data into a BECS system could be used for automating data entry of all manner of patient care data into an EMR.

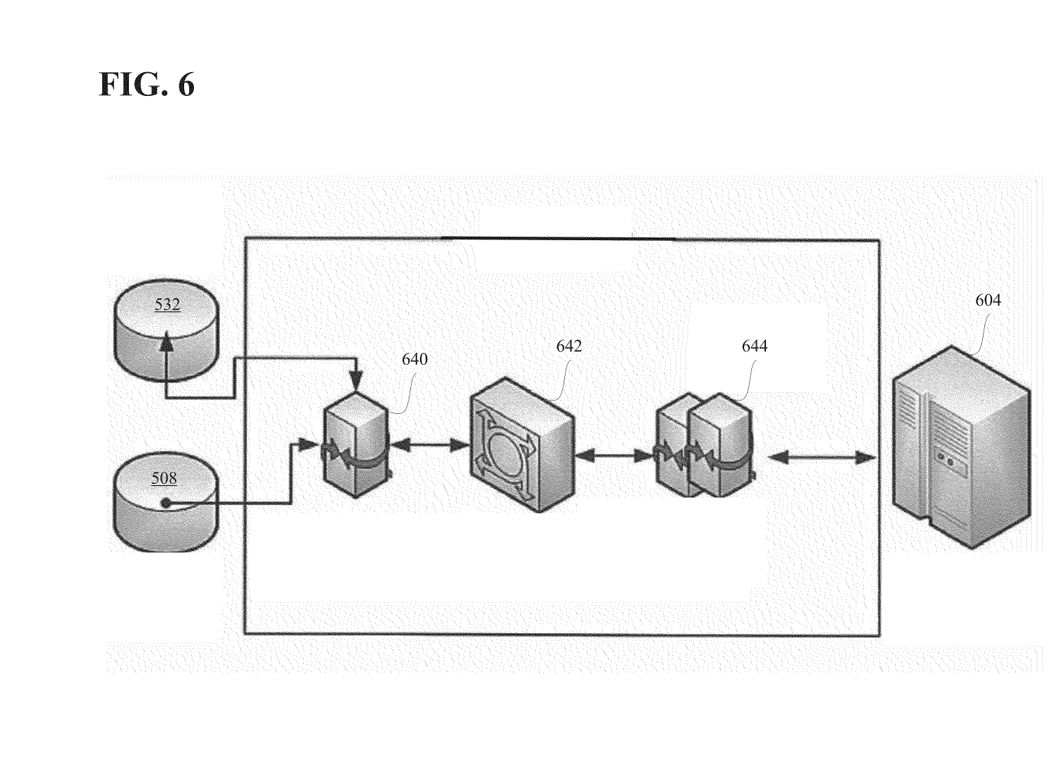

FIG. 6 illustrates a computer architecture including hardware and software that further illustrates the transfer of data from a donor screening system 608 and DMR database tables 632 to blood records management system 604. The computer architecture can be configured to access data in the donor screening system and process the data without modifying the data, transfer the data to the blood records management system, and provide a user interface so that trained operators can deal with data exceptions, view history logs, and monitor processing. A DMR synchronization service 640 can synchronize DMR data from the donor screening system and the DMR database. The synchronization services can be regularly scanned for batches of data entry and data management activities that need to be entered into the blood records management system. When a batch is identified as available for automated data entry, the batch data entry logic module 642 can be activated and enter the data into the blood records management system, such as with the terminal emulation described above. In some embodiments, this entry is facilitated by a web service 644 that communicates between the module and the blood records management system. In some embodiments, the DMR synchronization service and the batch data entry logic module can be integrated into a single module. For example, the batch data entry logic module can be configured to identify batches of data entry and data management activities that need to be entered into the blood records management system (e.g., through screen scraping, or similar data acquisition methods), and the batch data entry logic module can be further configured to automatically enter the batches of data into the blood records management system, such as with terminal emulation. Thus, the batch data entry logic module can be configured to serve the function of the computing systems described herein, bridging the gap between blood collection devices, donor screening systems, and blood records management systems by gathering, sorting, and submitting blood collection and donor information between the collection devices and various database systems in a blood collection event.

As for additional details pertinent to the present invention, materials and manufacturing techniques may be employed as within the level of those with skill in the relevant art. The same may hold true with respect to method-based aspects of the invention in terms of additional acts commonly or logically employed. Also, it is contemplated that any optional feature of the inventive variations described may be set forth and claimed independently, or in combination with any one or more of the features described herein. Likewise, reference to a singular item, includes the possibility that there are plural of the same items present. More specifically, as used herein and in the appended claims, the singular forms “a,” “and,” “said,” and “the” include plural referents unless the context clearly dictates otherwise. It is further noted that the claims may be drafted to exclude any optional element. As such, this statement is intended to serve as antecedent basis for use of such exclusive terminology as “solely,” “only” and the like in connection with the recitation of claim elements, or use of a “negative” limitation. Unless defined otherwise herein, all technical and scientific terms used herein have the same meaning as commonly understood by one of ordinary skill in the art to which this invention belongs. The breadth of the present invention is not to be limited by the subject specification, but rather only by the plain meaning of the claim terms employed.

What is claimed is:

1. A Blood Establishment Computer System (BECS) automated data entry emulator comprising a non-transitory computer-readable storage medium storing a set of instructions capable of being executed by a computer, that when executed by the computer causes the computer to:
receive one or more sets of data from one or more medical devices comprising blood collection information and/or donor information;
format the data sets by formatting data within each set of data into data entry fields corresponding to data entry fields of a BECS system;
automatically write the formatted data sets into data entry fields of the BECS system;
generate a list of exceptions referencing any of the data sets for which the BECS system indicates an error or did not accept data from the data set; and
present the list of exceptions to a user to manually correct the data within the data sets referenced by the list of exceptions.

2. The BECS automated data entry emulator of claim 1, wherein the set of instructions when executed by the computer cause the computer to include on the list of exceptions a reference to any of the sets of data for which data cannot be formatted to correspond to the data entry fields of the BECS system.

3. The BECS automated data entry emulator of claim 1, wherein the set of instructions when executed by the computer cause the computer to apply a set of rules to the data within each set of data to determine if additional data is missing and to include a reference to any of the sets of data for which additional data is missing.

4. The BECS automated data entry emulator of claim 1, wherein the set of instructions when executed by the computer cause the computer to present the list of exceptions to the user to manually correct the data sets by providing an emulated BECS data entry screen.

5. The BECS automated data entry emulator of claim 1, wherein the set of instructions when executed by the computer cause the computer to log into the BECS system and determine the format of the data entry fields of the BECS system.

6. The BECS automated data entry emulator of claim 1, wherein the set of instructions when executed by the computer further causes the computer to automatically write the corrected data sets from the formatted sets of data.

7. The BECS automated data entry emulator of claim 6, wherein the set of instructions when executed by the computer further causes the computer to generate an updated list of exceptions referencing any of the data sets for which the BECS system indicates an error or did not accept data from the data set.

8. A Blood Establishment Computer System (BECS) automated data entry emulator comprising a non-transitory computer-readable storage medium storing a set of instructions capable of being executed by a computer, that when executed by the computer causes the computer to:
receive one or more sets of data from one or more medical devices comprising blood collection information and/or donor information;
format the data within each set of data into data entry fields corresponding to data entry fields of a BECS system;
generate a first list of exceptions referencing any of the sets of data which cannot be formatted to correspond to the data entry fields of the BECS system;
apply a first set of exceptions rules to the data within each data set to determine if additional data is missing from one or more of the sets of data and include a reference to any data set missing the additional data on the first list of exceptions;
automatically write the formatted data sets not referenced on the first list of exceptions into data entry fields of the BECS system;
generate a second list of exceptions referencing any of the data sets for which the BECS system indicates an error; and
present the first and second list of exceptions to a user to manually correct the data within the data sets referenced by the first and second list of exceptions.

9. A method of managing blood collections, comprising the steps of:
receiving, with a computing system, blood collection information from a blood collection device;
inputting, with a terminal emulation software program of the computing system, the blood collection information into a blood records management system; and
identifying, with a screen scraping process of the terminal emulation software program, errors in the blood collection information.

10. The method of claim 9 further comprising, in response to identifying the errors in the blood collection information, flagging the identified errors for review by a user.

11. The method of claim 10, further comprising applying a set of rules to the blood collection information to determine if additional data is missing and to include a reference to any of the sets of data for which additional data is missing.

12. The method of claim 10, further comprising presenting the identified errors to the user to manually correct the inputting of blood collection information into the blood records management system.

13. The method of claim 9, wherein errors in the blood collection information are selected from the group consisting of time and location of the blood collection, amount of blood withdrawn, blood type, employee ID of the phlebotomist responsible for collection of the blood, elapsed time of blood collection, and interruptions of the blood donation process.

14. The method of claim 9 wherein the blood donor screening system comprises Donor-ID.

15. The method of claim 9 wherein the blood records management system comprises SafeTrace.

16. The method of claim 9 wherein the inputting step further comprises emulating, with the terminal emulation software program of the computing system, manual data entry of the blood collection information into the blood records management system.

17. The method of claim 9, further comprising the step of formatting the blood collection information into data entry fields corresponding to data entry fields of the blood records management system.

18. A method of managing blood collections, comprising the steps of:
receiving, with a computing system, blood collection information or donor information from a blood donor screening system or a blood collection device;
emulating, with the computing system, the blood collection information or donor information into a blood records management system; and
identifying, with the computing system, errors in the blood collection information, errors in the donor information, or errors produced by the blood records management system.

19. The method of claim 18 further comprising, in response to identifying the errors in the blood collection information or donor information, flagging the identified errors for review by a user.

20. The method of claim 19, further comprising applying a set of rules to the blood collection information or donor information to determine if additional data is missing and to include a reference to any of the sets of data for which additional data is missing.

21. The method of claim 19, further comprising presenting the identified errors to the user to manually correct the inputting of blood collection information or donor information into the blood records management system.

22. The method of claim 18, wherein errors in the blood collection information or donor information are selected from the group consisting of time and location of the blood collection, amount of blood withdrawn, blood type, employee ID of the phlebotomist responsible for collection of the blood, elapsed time of blood collection, and interruptions of the blood donation process.

23. The method of claim 18 wherein the blood donor screening system comprises Donor-ID.

24. The method of claim 18 wherein the blood records management system comprises SafeTrace.

25. The method of claim 18 wherein the inputting step further comprises emulating, with the terminal emulation software program of the computing system, manual data entry of the blood collection information or donor information into the blood records management system.

26. A blood collection and tracking system, comprising:
a blood collection device configured to collect blood from a patient and to collect information relating to the collected blood;
a donor screening system configured to provide information relating to the patient's eligibility to donate blood;
a blood records management system comprising a database of information relating to blood donation and distribution; and
a batch data entry logic module configured to receive information relating to the collected blood from the blood collection device, configured to receive information relating to the patient's eligibility to donate blood from the donor screening system, and further configured to enter the information relating to the collected blood and the patient's eligibility to donate blood into the blood records management system with a terminal emulation algorithm.
